(19) United States
(12) Patent Application Publication
(10) Pub. No.: US 2012/0278644 A1
(43) Pub. Date: Nov. 1, 2012

(54) POWER MANAGEMENT DEVICE, HIGH PERFORMANCE SERVER AND POWER MANAGEMENT METHOD

(76) Inventors: Hsin-Yuan CHEN, Taipei (TW); Yan-Tang Liu, Taipei (TW)

(21) Appl. No.: 13/457,945

(22) Filed: Apr. 27, 2012

(30) Foreign Application Priority Data
Apr. 29, 2011 (TW) 100115143

(51) Int. Cl. G06F 1/28

(52) U.S. Cl. 713/340

(57) ABSTRACT

A power management device cooperated with a plurality of computing units and a plurality of power supply units is disclosed. The power supply units provide the power source to the computing units through the power management device. The power management device includes a detecting module and a control module. The detecting module is operatively connected with the computing units, and detects a total consumption power of the computing units. The control module is operatively connected with the detecting module and the power supply units, and adjusts the operation amount of the power supply units providing the power source to the computing units in accordance with the total consumption power. In addition, a high performance server and a power management method are also disclosed.

### CROSS REFERENCE TO RELATED APPLICATIONS

This Non-provisional application claims priority under 35 U.S.C. §119(a) on Patent Application No(s). 100115143 filed in Taiwan, Republic of China on Apr. 29, 2011, the entire contents of which are hereby incorporated by reference.

### BACKGROUND

1. Technology Field

The disclosure relates to a power management device, a high performance server and a power management method.

2. Related Art

Referring to FIG. 1A, in the present server S, multiple of power supply units U are applied with a power management device 1 to provide the required power to the server S. In this structure, the power management device 1 converts the outputted voltage from the power supply units U and provides the converted voltage to the server S.

The power management device 1 not only converts the voltage but also monitors the power supply units U if functioning normally or abnormally. Because that the power supply units U evenly provide the required power source to the server S, when the server S is under low power requirement, each power supply unit U would be in low-load status. However, as shown in FIG. 1B, the operation efficiency of the power supply units U in low-load or medium-load status is lower than that of the power supply units U in heavy-load status. In other words, the server S under lower power requirement would lead to bad conversion efficiency of the power supply units U and can not satisfy the demands and trends of environment protection and energy saving for new technologies.

### SUMMARY

A power management device, a high performance server and a power management method for adjusting the operation amount of power supply units according to the variation of the power requirement are provided, thereby raising the power conversion efficiency.

A power management device is cooperated with a plurality of computing units and a plurality of power supply units. The power supply units provide a power source to the computing units through the power management device. The power management device includes a detecting module and a control module. The detecting module is operatively connected with the computing units and detects a total consumption power of the computing units. The control module is operatively connected with the detecting module and the power supply units, and adjusts the operation amount of the power supply units providing the power source to the computing units in accordance with the total consumption power.

In one embodiment, each of the computing units comprises a server main board.

In one embodiment, the control module comprises a micro control unit or a micro processor.

In one embodiment, the detecting module detects the total consumption power of the computing units and outputs a detecting signal to the control module.

In one embodiment, the control module further comprises a memory unit, a comparing unit and a control unit. The memory unit stores at least a default value. The comparing unit is operatively connected with the memory unit and the detecting module for comparing the default value with the detected value so as to output a comparing signal. The control unit is operatively connected with the comparing unit and the power supply units for adjusting the operation amount of the power supply units in accordance with the comparing signal.

A high performance server comprises a plurality of computing units, a plurality of power supply units, and a power management device. The power supply units are used to provide power source to the computing units through the power management device. The power management device comprises a detecting module and a control module. The detecting module is operatively connected with the computing units for detecting a total consumption power of the computing units. The control module is operatively connected with the detecting module and the power supply units for adjusting the operation amount of the power supply units providing the power source to the computing units in accordance with the total consumption power.

In one embodiment, the high performance server further comprises a plurality of fan modules operatively connected with the control module of the power management device. The control module adjusts the operation amount of the fan modules in accordance with the temperature of the computing units.

In one embodiment, each of the computing units comprises a server main board.

In one embodiment, the detecting module detects the total consumption power of the computing units and outputs a detecting signal to the control module.

In one embodiment, the control module further comprises a memory unit, a comparing unit, and a control unit. The memory unit stores at least a default value. The comparing unit is operatively connected with the memory unit and the detecting module for comparing the default value with the detected value so as to output a comparing signal. The control unit is operatively connected with the comparing unit and the power supply units for adjusting the operation amount of the power supply units in accordance with the comparing signal.

A power management method is cooperated with a plurality of computing units and a plurality of power supply units. The power management method comprises the following steps of providing power source to the computing units by the power supply units; detecting a total consumption power of the computing units; and adjusting the operation amount of the power supply units providing the power source to the computing units in accordance with the total consumption power.

In one embodiment, the power management method further comprises the following steps of: outputting a detecting signal in accordance with the total consumption power; comparing the detecting signal with a default value to generate a comparing signal; and adjusting the operation amount of the power supply units in accordance with the comparing signal.

In one embodiment, the power management method further comprises the following steps of: detecting the temperature of the computing units; and adjusting the operation amount of fan modules in accordance with the temperature of the computing unit.

In one embodiment, the computing unit comprises a server main board.

As mentioned above, the power management device, high performance server and power management method of the present invention are configured with the control module for adjusting the operation amount of the power supply units in accordance with the total consumption power of the computing units, so as to adjust the operation amount of the power supply units in accordance with the variation of the power requirement, thereby raising the power conversion efficiency.

These and other features, aspects and advantages of the present invention will become better understood with regard to the following description, appended claims, and accompanying drawings.

### BRIEF DESCRIPTION OF THE DRAWINGS

FIG. 1A is a schematic graph of a conventional power management device;

FIG. 1B is a waveform graph of the load vs. efficiency of the conventional power management device;

FIG. 2 is a schematic graph of a power management device according to a preferred embodiment of the present invention;

FIG. 3 is another schematic graph of a power management device according to a preferred embodiment of the present invention;

FIG. 4 is a flow chart of a power management method according to a preferred embodiment of the present invention;

FIG. 5 is a schematic graph of a high performance server according to a preferred embodiment of the present invention; and

FIG. 6 is another schematic graph of a high performance server according to a preferred embodiment of the present invention.

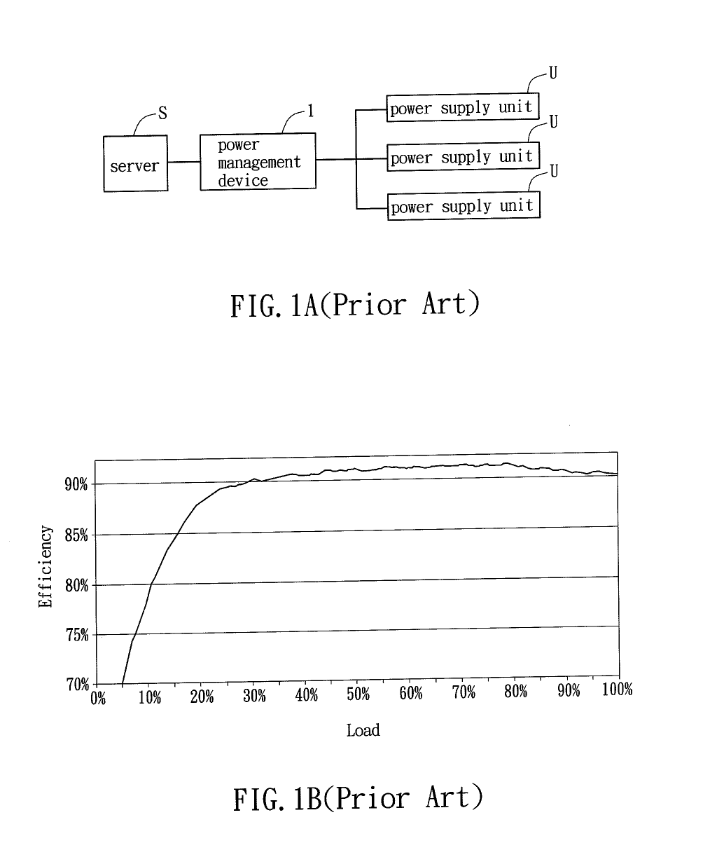

### DETAILED DESCRIPTION OF THE INVENTION

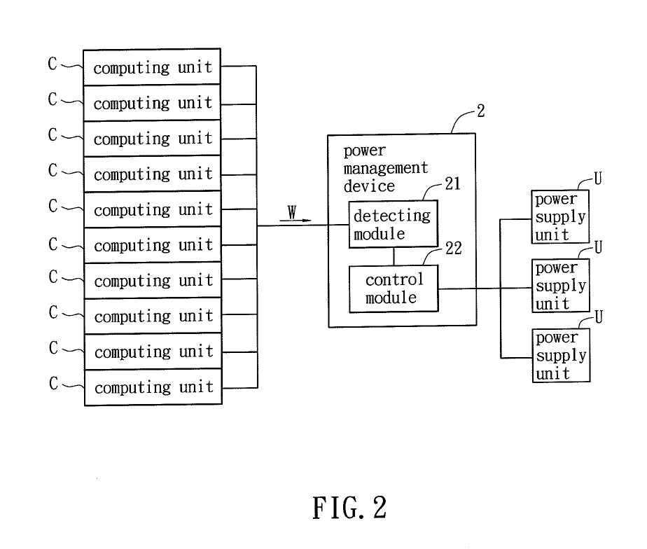

FIG. 2 shows a power management device 2 according to a preferred embodiment of the present invention. Referring to FIG. 2, the power management device 2 cooperates with a plurality of the computing units C and a plurality of the power supply units. In practice, the computing units C can include a server main board. This embodiment is an example that the power management device 2 cooperates with ten computing units C and three power supply units U, but the present invention is not limited to this case.

In practice, the amounts of the computing units and the power supply units can vary depending on the design of the product and the actual requirements.

The power management device 2 includes a detecting module 21 and a control module 22. The detecting module 21 is operatively connected with the computing units C and is used to detect a total consumption power W of the computing units C. The detecting module 21 outputs the detected result to the control module 22. The control module 22 is operatively connected with the detecting module 21 and the power supply units U. The control module 22 receives the detected result outputted from the detecting unit 21 and then adjusts the operation amount of the power supply units U providing the power source to the computing units C in accordance with the total consumption power W of the computing units C, and then optimizes the power conversion efficiency of the power supply units U. In practice, the control module 22 can include a micro control unit (MCU) or a micro processor.

Besides, in this embodiment, the control module 22 and the detecting module 21 are coupled to each other and are separate elements. However, in practice, the control module 22 can be integrally formed with the detecting module 21 as a single unit or a single module.

It is worth mentioned that the power management device 2 also has the functions of voltage conversion and monitoring the power supply unit U functioning normally to unusually. Since this feature is not the point of the present invention, there would be no further description here.

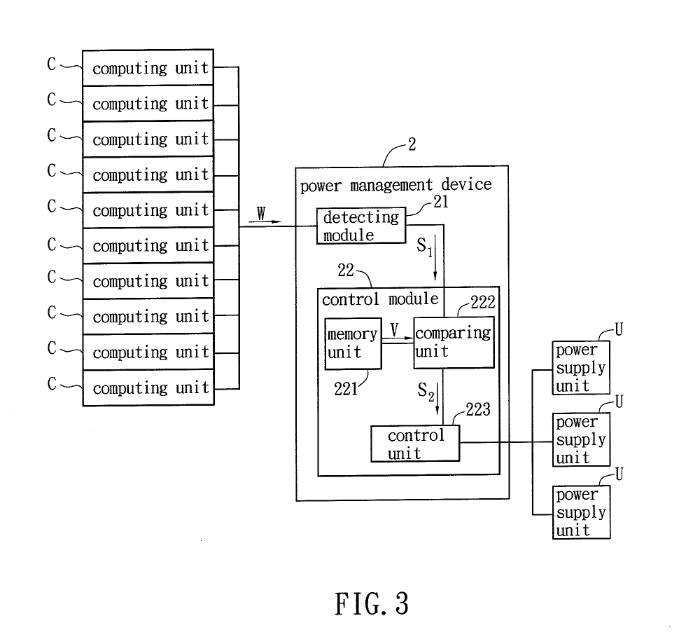

The power management device 2 of the present invention will be further described with reference to FIG. 3. In this embodiment, the control module 22 of the power management device 2 can comprise a memory unit 221, a comparing unit 222 and a control unit 223.

The memory unit 221 saves at least one default value V. In this case, the default value is related to the power value provided by the power supply units U, for example: the normal rated power or a multiple of the normal rated power of the power supply units U. The comparing unit 222 is operatively connected with the memory unit 221 and the detecting module 21. The comparing unit 222 is used to compare the default value V with the detected signal S₁ outputted by the detecting module 21 in accordance with the total consumption power W of the computing units C and produce a comparing signal S₂. The control unit 223 is operatively connected with the comparing unit 222 and the power supply units U and adjusts the operation amount of the power supply units U in accordance with comparing signal S₂.

In practice, if the normal rated power of each power supply unit U is 1400 Watt, when the real total consumption power W of the computing units C detected by the detecting unit 21 exceeds 2800 watt, for example 3000 watt, the control unit 223 of the control module 22 would make each of the power supply units U in operation status to provide required power source to the computing units C. If the current total consumption power W of the computing units C detected by the detecting module 21 is under 2800 Watt, for example 2500 Watt, because that 2500 Watts exceeds the normal rated power provided by a power supply unit U and is lower than the normal rated power provided by two power supply units U, the control unit 223 would turn off one power supply unit U and use two power supply units U to provide the required power to the computing units C. If the current total consumption power W is lower that 1400 Watt, the control unit 223 of the control module 22 would turn off two power supply units U and use only one power supply unit U to provide the power required to the computing units C.

Therefore, because of the hardware structure mentioned above, the power management device 2 decides the actual required operation amount of power supply units U in accordance of the total consumption power W of the computing units C, and then optimizes the power conversion efficiency of the power supply units U and rises the power conversion efficiency.

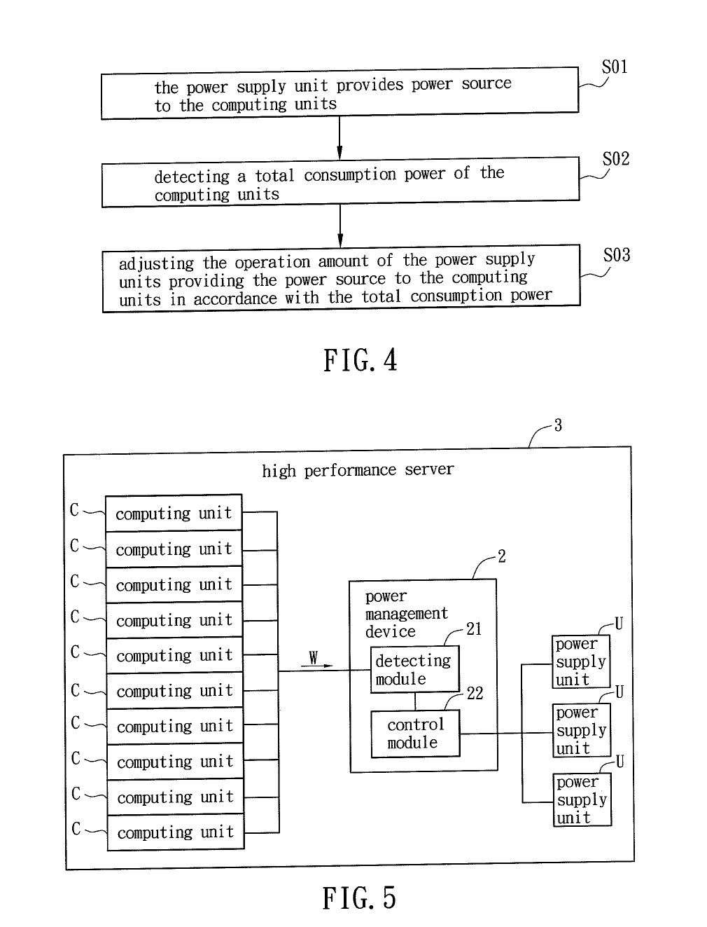

The power management method according to a preferred embodiment of the present invention will be described hereinafter with reference to the flow chart of FIG. 4 in view of the diagrams shown in FIG. 2 and FIG. 3. The power management method is cooperated with the above-mentioned power management device 2, the plurality of the computing units C, and the plurality of the power supply units U. The power management method includes the steps S01 to S03.

In the step S01, the power supply unit U provides power source to the computing units C. In this embodiment, the power supply unit U provides the required power to the computing units C through the power management device 2. The computing units C include a server main board.

The step S02 is to detect a total consumption power W of the computing units C. In this embodiment, the detecting module 21 of the power management device 2 is operatively connected with the computing units C, and is used to detect a total consumption power W of the computing units C. The detecting units 21 can output the detected result to the control module 22. The computing units C can include a server main board.

The step S03 is to adjust the operation amount of the power supply units U providing the power source to the computing units C in accordance with the total consumption power W. In this embodiment, the control module 22 is operatively connected with the detecting module 21 and the power supply units U, and receives the detected result outputted by the detecting module 21. Then, the control module 22 adjusts the operation amount of the power supply units U in accordance with the total consumption power W of the computing units C.

In detail, the power management method can further include the steps of: outputting a detected signal S₁ in accordance with the total consumption power W; comparing the detected signal S₁ with a default value V and producing a comparing signal S₂; and adjusting the operation amount of the power supply units U in accordance with the comparing signal S₂.

In this embodiment, the memory unit 221 of the control module 22 stores at least one default value V, which is, for example, a normal rated power or a multiple of the normal rated power of the power supply units U. The comparing unit 222 of the control module 22 is operatively connected with the memory unit 221 and the detecting module 21. The comparing unit 222 is used to compare the default value V with the detected signal S₁ outputted by the detecting module 21 in accordance with the total consumption power W and produce a comparing signal S₂. The control unit 223 of the control module 22 would adjust the operation amount of the power supply units U in accordance with the comparing signal S₂, make the power supply units U vary with the power requirement of the computing units C and optimize the power conversion efficiency.

FIG. 5 shows a high performance server 3 according to a preferred embodiment of the present invention. Referring to FIG. 5, the high performance server 3 includes a plurality of the computing units C, a plurality of the power supply units U and a power management device 2. It is worth mentioned that the high performance server 3 is not limited to certain appearance form, for example, the erect server, the rack type server or the blade type server. The high performance server 3 is also not limited to its computing capability, such as, file server, database server or application server. Besides, the computing units C can include a server main board.

The power supply units U provides the required power to the computing units C through the power management device 2. Besides, the power management device 2 includes a detecting module 21 and a control module 22. The detecting unit 21 is operatively connected with the control module 22 and is used to detect a total consumption power W of the computing units C. The control module 22 is operatively connected with the detecting module 21 and the power supply units U and adjusts the operation amount of the power supply units U providing power source to the computing units C in accordance with the total consumption power W.

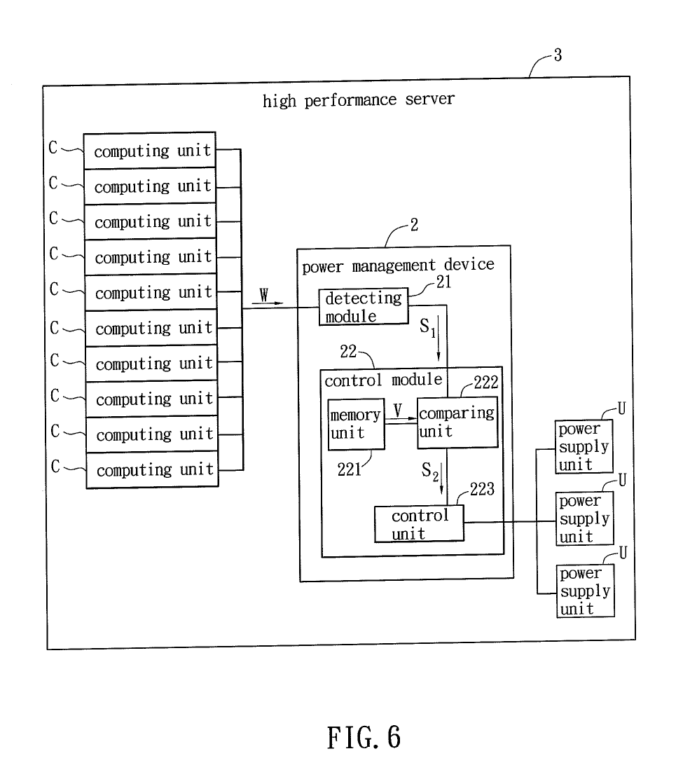

The high performance server 3 of the present invention will be further described hereinafter with reference to FIG. 6. In this embodiment, the high performance server 3 can further include a plurality of the fan modules F. The control module 22 of the power management device 2 further comprises a memory unit 221, a comparing unit 222 and a control unit 223.

The fan module F is operatively connected with the control module 22. In this embodiment, the high performance server 3 has 4 fan modules F for example. The control unit 223 of the control module 22 adjusts the operation amount of fan modules F in accordance with the temperature of the computing units C. In practice, the power management device 2 can detect the internal temperature of the electronic device E through the detecting module 21 or sense the temperature by another sensing unit.

In addition, the memory unit 221 saves at least one default value V. In this case, the default value is related to the power value provided by the power supply units U, for example: the normal rated power or a multiple of the normal rated power of the power supply units U. The comparing unit 222 is operatively connected with the memory unit 221 and the detecting module 21 and is used to compare the default value with the detected signal S₁ outputted by the detecting module 21 in accordance with the total consumption power W of the computing units C and then produces a comparing signal S₂. The control unit 223 is operatively connected with the comparing unit 222 and the power supply units U, and adjusts the operation amount of the power supply units U in accordance with the comparing signal S₂.

Because that parts of the steps of the power management method of the high performance server 3 are the same as those of the power management device 2 mentioned above, there would be no further description on the same steps here. In addition, the power management method of the high performance server 3 further includes the steps as following: detecting the temperature of the computing units C; and adjusting the operation amount of the fan modules F in accordance with the temperature of the computing units C. In this embodiment, the high performance server 3 comprises a plurality of the fan modules F to adjust the temperature of the computing units C. The control unit 223 of the control module 22 would adjust the operation amount of the fan modules F in accordance with the temperature of the computing units C to raise the efficiency of the power supply units U.

In summary, the power management device, high performance server and power management method of the present invention are configured with the control module for adjusting the operation amount of the power supply units in accordance with the total consumption power of the computing units, so as to adjust the operation amount of the power supply units in accordance with the variation of the power requirement, thereby raising the power conversion efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A power management device, cooperated with a plurality of computing units and a plurality of power supply units, wherein the power supply units provide a power source to the computing units through the power management device, the power management device comprising:
a detecting module operatively connected with the computing units for detecting a total consumption power of the computing units; and
a control module operatively connected with the detecting module and the power supply units for adjusting the operation amount of the power supply units providing the power source to the computing units in accordance with the total consumption power.

2. The power management device according to claim 1, wherein each of the computing units comprises a server main board.

3. The power management device according to claim 1, wherein the control module comprises a micro control unit or a micro processor.

4. The power management device according to claim 1, wherein the detecting module detects the total consumption power of the computing units and outputs a detecting signal to the control module.

5. The power management device according to claim 4, wherein the control module further comprises:
a memory unit storing at least a default value;
a comparing unit operatively connected with the memory unit and the detecting module for comparing the default value with the detected value so as to output a comparing signal; and
a control unit operatively connected with the comparing unit and the power supply units for adjusting the operation amount of the power supply units in accordance with the comparing signal.

6. A high performance server, comprising:
a plurality of computing units;
a plurality of power supply units used to provide power source to the computing units; and
a power management device, wherein the power supply units provide the power source to the computing units through the power management device, and the power management device comprises:
a detecting module operatively connected with the computing units for detecting a total consumption power of the computing units, and
a control module operatively connected with the detecting module and the power supply units for adjusting the operation amount of the power supply units providing the power source to the computing units in accordance with the total consumption power.

7. The high performance server according to claim 6, further comprising:
a plurality of fan modules operatively connected with the control module of the power management device.

8. The high performance server according to claim 7, wherein the control module adjusts the operation amount of the fan modules in accordance with the temperature of the computing units.

9. The high performance server according to claim 6, wherein each of the computing units comprises a server main board.

10. The high performance server according to claim 6, wherein the detecting module detects the total consumption power of the computing units and outputs a detecting signal to the control module.

11. The high performance server according to claim 6, wherein the control module further comprises:
a memory unit storing at least a default value;
a comparing unit operatively connected with the memory unit and the detecting module for comparing the default value with the detected value so as to output a comparing signal; and
a control unit operatively connected with the comparing unit and the power supply units for adjusting the operation amount of the power supply units in accordance with the comparing signal.

12. A power management method cooperated with a plurality of computing units and a plurality of power supply units, comprising the following steps of:
providing power source to the computing units by the power supply units;
detecting a total consumption power of the computing units; and
adjusting the operation amount of the power supply units providing the power source to the computing units in accordance with the total consumption power.

13. The power management method according to claim 12, further comprising:
outputting a detecting signal in accordance with the total consumption power;
comparing the detecting signal with a default value to generate a comparing signal; and
adjusting the operation amount of the power supply units in accordance with the comparing signal.

14. The power management method according to claim 12, further comprising:
detecting the temperature of the computing units; and
adjusting the operation amount of fan modules in accordance with the temperature of the computing unit.
